(19) United States
(12) Patent Application Publication
(10) Pub. No.: US 2015/0342391 A1
(43) Pub. Date: Dec. 3, 2015

(54) RAMEN COOKER HAVING CONTAINER IDENTIFICATION FUNCTION

(71) Applicant: Min Ho SEO, Bucheon-si Gyeonggi-do (KR)

(72) Inventor: Min Ho SEO, Bucheon-si (KR)

(21) Appl. No.: 14/758,570

(22) PCT Filed: Dec. 24, 2013
(86) PCT No.: PCT/KR2013/012070

§ 371 Date: Jun. 30, 2015

(30) Foreign Application Priority Data
Dec. 31, 2012 (KR) 10-2012-0158677

(51) Int. Cl. A47J 27/18

(52) U.S. Cl. CPC A47J 27/18

(57) ABSTRACT

Disclosed is a ramen cooker having a container identification function. The ramen cooker includes: an operation initiating unit that generates a purchase initiation signal showing an initiation of a ramen purchase operation in response to an external operation initiating action; a container identification unit that identifies the ramen container; a water injecting unit that injects water having a predetermined temperature into the ramen container in cases where the ramen container is determined to be purchased by the container identification unit; and a container heating unit that boils the ramen by applying heat to the ramen container injected with the water for a predetermined period of time and boiling the water in cases where the ramen container is determined to be purchased by the container identification unit. The ramen cooker according to the present invention cooks only a specific ramen container suitable for a specific ramen cooker and does not cook ramen in a non-related ramen container, and can thus prevent fires and fire-related accidents that may occur from injecting water into a non-cooking material or heating the water.

### TECHNICAL FIELD

The present invention relates to a ramen container having a container identification function.

### BACKGROUND ART

Various vending machines such as a beverage vending machine, a coffee vending machine and a tissue-paper vending machine have been used. The vending machine is an unmanned apparatus that provides a specific product when a user inputs a predetermined coin and then presses a purchase button.

Among them, there is a vending machine that sales a ramen used as simple food. Korean Patent Registration No. 1051976 (vessel transfer system of noodle automatic vending machine) discloses a technology in which a support frame, which settles a vessel on a slide section which horizontally moves with a simple configuration while being supported by a buffer section, stably moves toward a heating unit and a discharging unit, and settles the vessel while horizontally maintaining the vessel.

However, according to the related art, since the ramen is not cooked in the outside, it is difficult for the user to check the cooking state. Furthermore, according to the related art, even though the ramen is cooked in the outside, since the ramen is cooked even in an arbitrarily selected ramen vessel, there is a problem that the user exposed in a dangerous situation such as burn and fire.

The background art described above relates to technical information which is retained by the inventor in order to derive the present invention or is obtained by the inventor in a process of deriving the present invention, and is not necessarily a known art published to the general public before the present invention is filed.

### DISCLOSURE

### Technical Problem

The present invention provides a ramen cooker capable of cooking a ramen in a specific ramen container by coupling identification means to the ramen container.

Further, the present invention provides a ramen cooker capable of previously prevent fire and conflagration that may occur by injecting water in an object that is not for cooking or heating this object by cooking a ramen in only a specific ramen container suitable for a specific ramen cooker without cooking a ramen in a ramen container which is not related to the specific ramen cooker.

The technical problems suggested by the present invention should be easily understood through the following description.

### Technical Solution

In accordance with an aspect of the present invention, there is provided a ramen cooker including: an operation initiating unit that generates a purchase initiation signal representing an initiation of a ramen purchase operation in response to an external operation initiating action; a container identification unit that identifies the ramen container; a water injecting unit that injects water having a predetermined temperature into the ramen container when the container identification unit determines that the ramen container is for sale; and a container heating unit that boils the water by applying heat to the ramen container into which the water is injected for a predetermined period of time, and cook a ramen when the container identification unit determines that the ramen container is for sale.

Here, the container identification unit may include an identification means reading unit that reads identification means coupled to the ramen container; and a container determining unit that determines whether or not the ramen container is for sale by using the read identification means.

In the present embodiment, the ramen cooker may further include a weight sensing unit that measures a weight of the ramen container which is positioned on the container heating unit and into which the ware is injected, and operates the container heating unit when the measured weight is equal to or greater than a threshold.

In the present embodiment, the ramen cooker may further includes a cover that covers the container heating unit such that heat of the container heating unit is not transferred to the outside when the measured weight is less than the threshold after the operation of the container heating unit is completed and the ramen container is removed from the container heating unit; and a cover control unit that controls the cover to cover the container heating unit when the measured weight is less than the threshold.

Here, the cover may cover a front surface of the ramen cooker in a curtain manner.

In the present embodiment, the ramen cooker may further include water adjusting means for adjusting the amount of water injected into the ramen container from the water injecting unit.

Here, the identification means coupled to the ramen container may be any one or more of a one-dimensional barcode, a two-dimensional barcode, a QR code, and a two-dimensional bitmap code.

The container identification unit may be a groove having a predetermined shape that accommodates the ramen container, and it may be determined that the ramen container is for sale when the ramen container corresponding to the shape of the groove is inserted.

Other aspects, features, and merits other than the aforementioned aspects, features and merits should be clear from the following drawings, claims and detained description of the present invention.

### Effect of the Invention

In accordance with the ramen cooker according to the present invention, there is an effect of previously preventing fire and conflagration that may occur by injecting water in an object that is not for cooking or heating this object by cooking a ramen in only a specific ramen container suitable for a specific ramen cooker without cooking a ramen in a ramen container which is not related to the specific ramen cooker.

### DESCRIPTION OF DRAWINGS

FIG. 1A is a block configuration diagram of a ramen cooker having a container identification cooker according to an embodiment of the present invention.

FIG. 1B is a flowchart showing an operation flow of the ramen cooker having a container identification function according to the embodiment of the present invention.

FIG. 2 is a perspective view of the ramen cooker having a container identification function according to the embodiment of the present invention.

FIG. 3 is a diagram showing a ramen container used in the ramen cooker having a container identification function according to the embodiment of the present invention.

FIG. 4 is a perspective view of a ramen cooker having a container identification function according to another embodiment of the present invention.

FIG. 5 is a perspective view of a ramen cooker having a container identification function according to still another embodiment of the present invention.

### BEST MODE

The present invention may be changed in various forms, and may be implemented as various embodiments. Specific embodiments will be illustrated in the drawings and described in detail in the detailed description. However, it should be understood that the present invention is not limited to the specific embodiments, and the present invention includes all changes, equivalents and substitutions included in the spirit and technical scope of the present invention.

Although the terms including an ordinal number such as first or second may be used to describe various elements, but the elements are not limited to these terms. These terms are used to distinguish one element from another element.

It will also be understood that when an element is referred to as being “connected” or “coupled” to another element, the element may be directly connected or coupled to the other element or intervening elements may be present.

The terms used in the present specification are for the purpose of describing particular embodiments only, and are not intended to be limiting of the present invention. The singular forms are intended to include the plural forms as well, unless the context clearly indicates otherwise. It will be further understood that the terms “comprises (comprising)”, “includes (including)”, or “have (having)” in the present specification specify the presence of features, numerals, steps, operations, elements, components, or combinations thereof stated in the present specification, but do not preclude the presence or addition of one or more other features, numerals, steps, operations, elements, components, or combinations thereof.

The terms “ . . . unit”, “ . . . module”, and “ . . . means” described in the present specification refer to a unit for processing at least one function or operation, and may be implemented as hardware, software, or a combination thereof.

In describing the present invention with reference to the accompanying drawings, the same elements will be assigned the same reference numerals irrespective of the reference references assigned to the drawings, and thus, the redundant description thereof will be omitted. In describing the present invention, when it is determined that the specific description of the known related art unnecessarily obscures the gist of the present invention, the detailed description thereof will be omitted.

The present invention may be applied to a device that cooks various foods. Hereinafter, for the sake of convenience in description, embodiments in which a ramen is cooked will be primarily described.

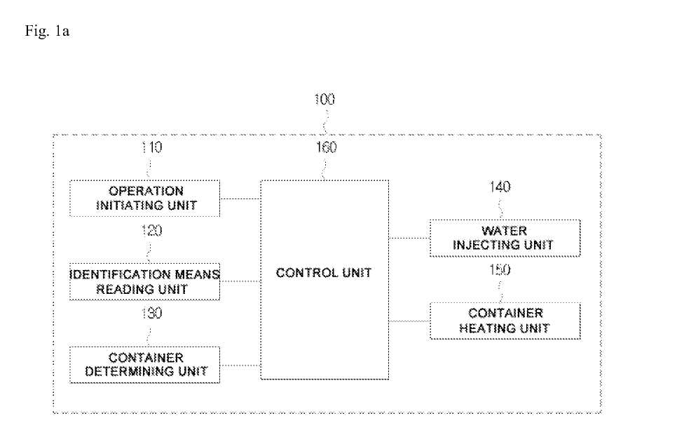

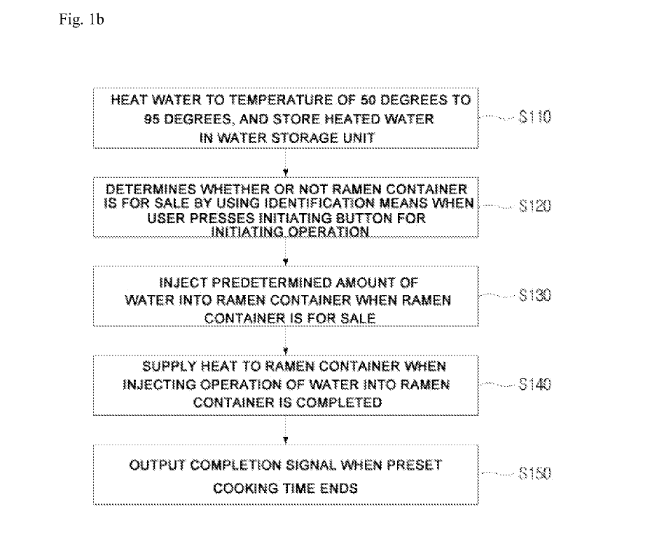

FIG. 1 is a block configuration diagram showing a ramen cooker having a container identification function according to an embodiment of the present invention. Referring to FIG. 1, a ramen cooker 100 includes an operation initiating unit 110, an identification means reading unit 120, a container determining unit 130, a water injecting unit 140, a container heating unit 150, and a control unit 160. Here, the identification means reading unit 120 and the container determining unit 130 may constitute a container identification unit for identifying a ramen container.

The present embodiment provides a ramen cooker capable of cooking a ramen in only a specific ramen container by coupling identification means to the ramen container. Specifically, in the present embodiment, the ramen cooker cooks the ramen by reading the identification means coupled to the ramen container, injecting water in the ramen container, and heating the ramen container.

The operation initiating unit 110 generates a purchase initiation signal representing an initiation of a ramen purchase operation in response to an external operation initiating action. For example, the external operation initiating action is an action performed by a user who uses the ramen cooker to initiate the purchase outside the ramen cooker 100, and may be an operation such as a press action of an initiating button for initiating the purchase, or an input action of money corresponding to a price of the ramen. The purchase initiation signal may be an initial generation signal for starting to cook and provide the ramen, and for example, may be generated in response to the press of a purchase button or the input of money.

In the present embodiment, a money input unit (not shown) that generates a money input signal when money corresponding to a purchase price of the ramen is input may be further included. In this case, the operation initiating unit 110 may generate the purchase initiation signal when the money input signal is received.

The identification means reading unit 120 reads the identification means coupled to the ramen container. The ramen container may include a container main body that accommodates the ramen therein, and a cover that opens and closes the container main body on a top surface. The identification means may be coupled to a side surface of the main body of the ramen container or the cover. For example, the identification means may be an ID barcode, or a 2D barcode. Alternatively, the identification means may be a quick response (QR) code, or a tow-dimensional bitmap code.

When the identification means is a barcode, the identification means reading unit 120 may be a barcode reader. In this case, the identification means reading unit 120 may read the identification means by using a camera, a laser beam, or infrared rays, and various means such as a RF frequency recognizing device or a Bluetooth frequency recognizing device may be used as the identification means reading unit 120.

The container determining unit 130 determines whether or not the ramen container is for sale by using the content of the identification means of the ramen container read by the identification means reading unit 120. Whether or not the ramen container is for sale may be found by determining whether or not the identification means is means for recording information corresponding to predetermined information.

If the identification means of the ramen container does not have the information corresponding to the predetermined information or the identification means is not coupled to the ramen container, the ramen may not be cooked in the present embodiment. In this case, in the present embodiment, information representing that the ramen container is not a suitable ramen container may be output to the outside through voice or electronic sound. Alternatively, a message or an image representing that the ramen container is not the suitable ramen container may be output on a screen.

According to the present embodiment, since the ramen is cooked in only a specific ramen container suitable for the specific ramen cooker 100 and the ramen is not cooked in a ramen container that is not related to the specific ramen cooker, it is possible too previously prevent fire and conflagration that may occur by injecting water in an object that is not for cooking or heating this object, and sales business of the ramen cooker 100 or sales business of the ramen container may be profit-making business.

When the container determining unit 130 determines that the ramen container is for sale, the water injecting unit 140 injects water having a predetermined temperature into the ramen container. After the ramen container is positioned on the container heating unit 150 to be described below, the identification means reading unit 120 may read the identification means coupled to the ramen container.

The water injecting unit 140 may inject a predetermined amount of water, for example, water having the amount capable of cooking the ramen corresponding to one meal. In this case, the amount of water may be 500 ml to 600 ml, specifically, about 550 ml.

The injected water may be input into the ramen container after the water is previously heated. For example, a temperature of water injected into the ramen container may be 50 degrees to 95 degrees, and in the present embodiment, a water storage unit (not shown) that stores the water injected into the container from the water injecting unit 140 at a temperature of 50 degrees to 95 degrees may be further included. In this case, since the previously heated water is injected into the container, it is possible to reduce a time necessary to cook the ramen.

The water may be supplied to the water injecting unit 140 from a directly connected water supply or a water bath inserted into an upper part of the water injecting unit. Further, the water injecting unit 140 may receive water purified through a purifying filter.

When the container 130 determines that the ramen container is for sale, the container heating unit 150 may boil the water by applying heat to the ramen container into which the water is injected for a predetermined period of time and may cook the ramen. The time necessary to cook the ramen may be a time necessary to deliciously cook the ramen. The time necessary to cook may be different depending on the amount of the ramen or the amount of water, and may be, for example, 2 minutes to 6 minutes.

In the present embodiment, time adjusting means for decreasing or increasing an operation time of the container heating unit 150 may be further provided. That is, as described above, the container heating unit 150 is previously set such that heat is applied to the ramen container for a predetermined period of time. However, in the present embodiment, time adjustment means for increasing or decreasing the heat applying time may be further provided. In this case, the user can adjust the cooking time of the ramen so as to be suitable for their tasty.

The container heating unit 150 may be various types of heat generating means, and for example, may generate heat by using a heating device to which various principles such as a gas stove, an electric stove, a microwave oven, and induction heater, a thermal-infrared heater, and a ceramic heater are applied.

When the container heating unit 150 is an induction heater that uses an induced current generated by a magnetic field as a heat source, a lower surface of the container may be made of metal in which the induced current generated by the induction heater can flow.

The number of container heating units 150 may be one or plural. In the latter case, the plurality of container heating units 150 may cook several ramens at the same time. In this case, the number of water injecting units 140 may be determined so as to correspond to the number of container heating units 150.

In the present embodiment, water adjusting means (not shown) for adjusting the amount of water injected into the ramen container from the water injecting unit 140 may be further included. The water adjusting means may be implemented in the form of a button. When the user presses the water adjusting means, the water is continuously supplied, or whenever the user presses the water adjusting means once, a unit amount of water, for example, 5 ml, 10 ml, 15 ml, or 20 ml may be injected to the ramen container.

When the number of water injecting units 140 is plural, the number of water adjusting means for adjusting the amount of water injected by the water injecting unit 140 may be determined so as to correspond to the number of water injecting units 140.

In the present embodiment, a weight sensing unit (not shown) that measures a weight of the ramen container into which water is injected and which is positioned on the container heating unit 150 and operates the water injecting unit 140 and/or the container heating unit 150 when the measured weight is equal to or greater than a threshold may be further included. That is, in the present embodiment, the weight of the ramen container into which the water is injected is measured in order to determine whether or not the water is injected to the ramen container. When the weight exceeds a predetermined threshold, it is determined that the water is injected to the ramen container.

In this case, the threshold of the weight is a weight measured when the aforementioned amount of water is injected into the ramen container, and may be the total weight of the ramen, the water, and the ramen container. For example, the threshold of the weight may be 500 g to 1500 g.

In the present embodiment, a detection sensor coupled to a front surface is provided, and thus, it is possible to check if a moving object is present in front of the ramen cooker 100. If the detection sensor does not detect the moving object for a predetermined period of time, the ramen cooker 100 according to the present embodiment may be in a standby state. The powers of the identification means reading unit 120, the container determining unit 130, the water injecting unit 140 and the container heating unit 150 are turned off in the standby state, and a standby power may be supplied to only the operation initiating unit 110.

The control unit 160 controls the respective functional units such that the operation initiating unit 110, the identification means reading unit 120, the container determining unit 130, the water injecting unit 140 and the container heating unit 150 perform their own functions in an interworking manner.

FIG. 1B is a flowchart showing an operation flow of the ramen cooker having a container identification function according to the embodiment of the present invention. The respective steps to be described below may be performed by the ramen cooker 100. It should be noted that the present invention is not limited to the following embodiments. The processes described for the respective steps may not be necessarily performed in a sequence of time. As long as the gist of the present invention is satisfied even though the order of performing the respective steps is changed, these processes may be included in the right scope of the present invention.

In step S110, the water may be firstly heated to a temperature of 50 degrees to 95 degrees described above, and may be stored in the water storage unit. The user removes the cover (lid) from the ramen container to which the identification means is attached, and places the ramen container on the container heating unit 150.

Subsequently, in step S120, when the user presses the operation initiating button for initiating the operation, the identification means reading unit 120 reads the identification means attached to the ramen container, and transmits the information stored in the identification means to the container determining unit 130. The container determining unit 130 determines whether or not the ramen container is for sale by using the information of the identification means.

In step S130, as the determined result, when the information of the identification means corresponds to previously stored or set information, the water injecting unit 140 injects water having a predetermined temperature into the ramen container by a predetermined amount. In this case, the powers of the identification means reading unit (120) and/or the container determining unit 130 may be turned off.

In step S140, when the injecting process of the water into the ramen container is completed, the container heating unit 150 is operated. The container heating unit 150 may apply heat to the ramen container at a predetermined temperature for a predetermined period of time.

Thereafter, in step S150, when the predetermined cooking time ends, in the present embodiment, a signal representing that the cooking is completed, for example, a completion signal using means such voice, electronic sound or emission light may be output.

If the user lifts the ramen container from the container heating unit 150 or the ramen container is not cooled even though a predetermined period of time elapses, the output of the completion signal is stopped. Even though the container heating unit 150 is heating the ramen container, when the ramen container is removed from the container heating unit 150, the container heating unit 150 detects the weight as described above, and stops the heat apply.

In this case, in the present embodiment, at the time of stopping the applying of the signal and/or the heat, the applying of the signal and/or the heat may be stopped after a predetermined period of time, for example, 5 seconds to 10 seconds elapse.

The ramen cooker having a container identification function of the present embodiment has been described with reference to the generally illustrated block configuration diagram and flowchart. The ramen cooker having a container identification function according to the present embodiment will be described with reference to the accompanying drawings in conjunction with specific embodiments. It should be noted that the present invention is not limited to such embodiments.

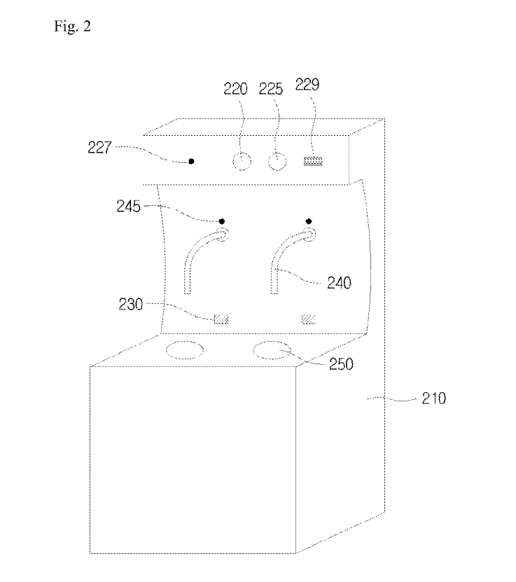

FIG. 2 is a perspective view of the ramen cooker having a container identification function according to the embodiment of the present invention. Referring to FIG. 2, a cooker main body 210, an initiating button 220, a water adjusting button 225, a power display light 227, a speaker 229, a barcode reader 230, a water injecting unit 240, a water injection display light 245, and a container heating unit 250 are illustrated.

The cooker main body 210 forms an external frame of the ramen cooker. The initiating button 220 may be a button for initiating the action, and may be positioned in front of the cooker main body in order for the user to easily press this button. The water adjusting button 225 may be a button for supplying the water or stopping the water being supplied as described above.

The power display light 227 is signal light for notifying that the power is currently applied, and the speaker 229 may be a device for outputting voice or electronic sound.

The barcode reader 230 may be provided toward a place for reading the identification means attached to the ramen container, for example, a side surface of the ramen container in front of the cooker main body 210.

In the drawing, it is illustrated that the barcode reader 230 is a fixed type, but this is merely an embodiment, and the barcode reader may be a handy type that is connected to the cooker main body 210 in a wired manner or a wireless manner when necessary.

Two water injecting units 240 and two container heating units 250 may be provided, and the water injection display light 245 may display whether or not the water can be currently supplied or the water is being supplied.

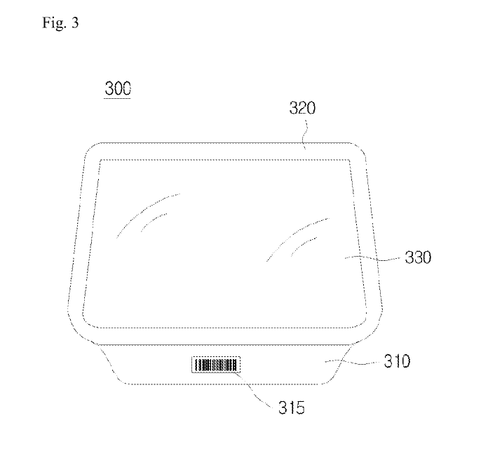

Referring to FIG. 3, it is illustrated that a top surface of the ramen container used in the ramen cooker according to the present embodiment has a square shape, but the shape thereof is not necessarily limited thereto, and for example, may be various shapes such as a circular shape, an elliptic shape and a polygonal shape.

A body 310 is a body for providing a space in which the ramen is accommodated, and an edge 320 is a part protruding from a side surface so as to allow the user to hold the hot ramen container without being burned.

Identification means 315 may be attached to a side surface of the body 310. As stated above, the identification means 315 may be a barcode.

As mentioned above, the edge 320 may be continuously formed at a frame of a top surface of a container 300 or may be formed at a part of the frame, for example, two frames facing each other on the square-shaped top surface. The edge 320 may be made of a heat insulating material, for example, paper, plastic, or wood.

A top cover 330 may be made of vinyl, plastic wrap, or aluminum. In the former case, the top cover 330 may be transparent, and in the latter case, the top cover 330 may be made of foil having a main material as aluminum.

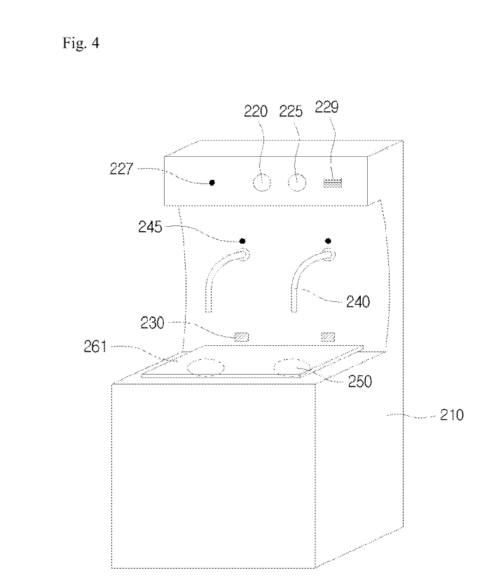

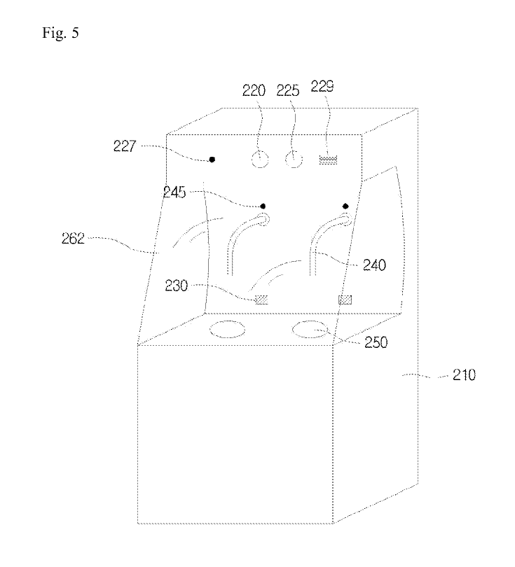

FIGS. 4 and 5 are perspective views of a ramen container having a container identification function according to another embodiment of the present invention. Hereinafter, a different from the aforementioned embodiment will be primarily described.

In the present embodiment, it is possible to prevent fire or burn from a high temperature by covering the container heating unit 150 of which heat remains after the ramen is cooked.

Specifically, in the present embodiment, after the operation of the container heating unit 150 is completed, when the ramen container is removed from the container heating unit 150 and the measured weight is less than the threshold, a cover for covering the container heating unit 150 so as not to allow the heat of the container heating unit 150 to be transmitted to the outside may be included. As shown in FIG. 4, the cover may be divided into a top cover 261 that covers a top surface of the container heating unit 250, and a front cover 262 that covers a front surface of the cooker main body 210.

In this case, in the present embodiment, when the weight measured on the container heating unit 150 is less than the aforementioned threshold, a cover control unit (not shown) that controls the cover so as to cover the container heating unit 150 may be included.

For example, the top cover 261 is inserted into the cooker main body 210 at the time of the operation of the ramen cooker 100, and when the top cover covers the container heating unit 150, the top cover escapes from the inside of the cooker main body 210, and thus, it is possible to cover the top surface of the container heating unit 150. In this case, the cover control unit may include a motor that moves the top cover 261, and a power control unit that supplies a current to the motor.

One side of the top cover 261 is coupled to an outer surface of the cooker main body 210 through a hinge, and the top cover rotates around the one side. In so doing, the container heating unit 150 can be covered.

Referring to FIG. 5, the front cover 262 may cover the front surface of the ramen cooker 100 in a curtain manner. In this case, the front cover 262 is inserted into the cooker main body 210 at the time of the operation of the ramen cooker 100. The front cover escapes from the inside of the cooker main body 210 when the front surface of the main body is covered, and thus, it is possible to cover the front surface.

According to another embodiment of the present invention, the container identification unit may identify the container by using the shape of the ramen container. For example, the container identification unit may be a groove having a predetermined shape for accommodating the ramen container. The container heating unit 150 may be positioned on a bottom surface of the groove.

Here, the shape of the groove may be a shape such as an elliptic shape, a polygonal shape, a chrysanthemum shape, a diamond shape, or a circular shape of which a groove is formed inward or outward in a part thereof such that only the ramen container according to the present embodiment can be inserted. In this case, the shape of the ramen container may be formed so as to correspond to the shape of the groove which is the container identification unit. When the user inserts the ramen container suitable for the shape of the container identification unit into the container identification unit, the ramen cooker according to the present embodiment injects the water into the ramen container, and heats the ramen container. Thus, it is possible to cook the ramen.

The weight sensing unit may determine whether or not the ramen container suitable for the container identification unit is inserted. For example, the weight sensing unit measures the weight of the ramen container when the ramen container is inserted into the container identification unit, and in the present embodiment, when the measured weight is equal to or greater than the threshold, the water injecting unit 140 and/or the container heating unit 150 may be operated.

in the present embodiment, when it is detected whether or not the ramen container is inserted into the container identification unit by using an infrared sensing unit and/or an object detection sensing unit as well as the weight sensing unit, and the ramen container is detected, the water injecting unit 140 and/or the container heating unit 150 can be operated. In this case, the infrared sensing unit and the object detection sensing unit are positioned on an inner surface of the groove which is the container identification unit, and thus, it is possible to detect the ramen container.

In addition to the aforementioned configuration of the ramen cooker according to the embodiment of the present invention, a common platform technology such as a specific system configuration, an embedded system, or an O/S, an interface standardization technology such as a communication protocol or an I/O interface, and a component standardization technology such as an actuator, a battery, a camera or a sensor are known to those skilled in the art, and thus, the detailed description thereof will be omitted.

A method of operating the ramen cooker according to the present invention may be implemented in the form of program commands, and may be recorded in a computer readable medium. That is, the recording medium may be a recording medium that records programs for causing a computer to execute the aforementioned steps so as to be read by the computer.

The computer readable medium may include program commands, data files, and data structures in a single manner or a combined manner. The program commands recorded in the medium may be specially designed or configured to achieve the present invention, or may be used by those involved in computer software. Examples of the computer readable medium include a hardware device specially configured to store program commands and execute the program codes, such as a magnetic media such as a hard disk, a floppy disk or a magnetic tape, an optical media such as a CD-Rom or a DVD, a magneto-optical media such as a floptical disk, a ROM, a RAM, and a flash memory.

The aforementioned elements may be implemented as one physically adjacent component or may be implemented as another component. In the latter case, the respective elements may be controlled in regions that are adjacent or different from each other, and in this case, the present invention may include separate control means or a separate control room that controls the respective elements, and may control the respective elements in a wired or wireless manner. The respective elements may be detachably coupled.

As described above, the respective elements and/or functions described in the respective embodiments may be implemented by being comprehensively combined. It should be understood to those skilled in the art that the present invention may be changed or modified in various manners without departing from the spirit and scope of the present invention described in the appended claims.

What is claimed is:

1. A ramen cooker comprising:
an operation initiating unit that generates a purchase initiation signal representing an initiation of a ramen purchase operation in response to an external operation initiating action;
a container identification unit that identifies the ramen container;
a water injecting unit that injects water having a predetermined temperature into the ramen container when the container identification unit determines that the ramen container is for sale; and
a container heating unit that boils the water by applying heat to the ramen container into which the water is injected for a predetermined period of time, and cook a ramen when the container identification unit determines that the ramen container is for sale.

2. The ramen cooker of claim 1,
wherein the container identification unit includes
an identification means reading unit that reads identification means coupled to the ramen container; and
a container determining unit that determines whether or not the ramen container is for sale by using the read identification means.

3. The ramen cooker of claim 1, further comprising:
a weight sensing unit that measures a weight of the ramen container which is positioned on the container heating unit and into which the ware is injected, and operates the container heating unit when the measured weight is equal to or greater than a threshold.

4. The ramen cooker of claim 3, further comprising:
a cover that covers the container heating unit such that heat of the container heating unit is not transferred to the outside when the measured weight is less than the threshold after the operation of the container heating unit is completed and the ramen container is removed from the container heating unit; and
a cover control unit that controls the cover to cover the container heating unit when the measured weight is less than the threshold.

5. The ramen cooker of claim 4,
wherein the cover covers a front surface of the ramen cooker in a curtain manner.

6. The ramen cooker of claim 1, further comprising:
water adjusting means for adjusting the amount of water injected into the ramen container from the water injecting unit.

7. The ramen cooker of claim 2,
wherein the identification means coupled to the ramen container is any one or more of a one-dimensional barcode, a two-dimensional barcode, a QR code, and a two-dimensional bitmap code.

8. The ramen cooker of claim 1,
wherein the container identification unit is a groove having a predetermined shape that accommodates the ramen container, and
it is determined that the ramen container is for sale when the ramen container corresponding to the shape of the groove is inserted.
